(19) United States
(12) Patent Application Publication
(10) Pub. No.: US 2026/0121114 A1
(43) Pub. Date: Apr. 30, 2026

(54) LITHIUM METAL SOLID-STATE BATTERIES AND THE FABRICATION METHOD THEREOF

(71) Applicant: City University of Hong Kong, Hong Kong (HK)

(72) Inventors: Qichun ZHANG, Hong Kong (HK); Chun-Sing LEE, Hong Kong (HK); Tuoya NAREN, Hong Kong (HK); Qianfeng GU, Fengyang City (CN)

(21) Appl. No.: 18/932,657

(22) Filed: Oct. 31, 2024

(51) Int. Cl. H01M 10/0565; H01M 4/02; H01M 4/38; H01M 4/62; H01M 50/491

(52) U.S. Cl. CPC H01M 10/0565; H01M 4/382; H01M 4/625; H01M 50/491; H01M 2004/027; H01M 2004/028

(57) ABSTRACT

A lithium metal solid-state battery includes a lithium metal anode and a cathode that includes an active material, a conductive material, a binder, and a current collector is provided. The active material has one or more lithium-based compounds selected from lithium cobalt oxide, lithium nickel manganese cobalt oxide, lithium iron phosphate, lithium manganese oxide, lithium sulfur, and lithium nickel cobalt aluminum oxide. The battery also includes at least one porous polymer separator with a porosity ranging from approximately 30% to 90%. The solid-state electrolyte includes an organogel, which contains covalent organic frameworks (COFs) fabricated through the condensation of monomers with a specified formula.

### FIELD OF THE INVENTION

The present invention generally relates to lithium-based batteries. More specifically the present invention relates to lithium metal solid-state batteries with covalent organic framework (COF) organogel as solid-state electrocyte.

### BACKGROUND OF THE INVENTION

Solid-state lithium batteries offer higher safety and energy density compared to traditional liquid electrolyte batteries. [1] The limitations of liquid electrolytes, such as flammability, volatility, and poor thermal conductivity, have significantly hindered their widespread use. Solid-state batteries address these issues by redesigning the electrolyte composition to enhance both safety and performance, presenting a promising alternative to conventional systems. [2]

Organic solid-state electrolytes, in particular, offer superior flexibility and low-temperature ionic conductivity compared to their inorganic counterparts, making them well-suited for low-temperature applications with improved safety profiles. [3] However, organic electrolytes can face challenges, such as melting or loss of crystallinity at high temperatures, which can compromise their long-term stability and ionic conductivity. Additionally, their lower mechanical strength may lead to physical damage within the electrolyte or structural issues in the battery. To overcome these drawbacks, composite solid-state electrolytes (CSEs) have emerged as a viable solution, combining multiple advantageous properties. By incorporating inorganic solid-state electrolyte fillers, CSEs enhance ionic conductivity, electrochemical stability, and mechanical strength. Despite these advancements, challenges remain, including the high crystallinity of polymer matrices, poor interfacial compatibility with inorganic fillers, and the difficulty in maintaining ionic conductivity, all of which present significant hurdles for optimizing solid polymer electrolytes. [4-6]

The unique structure of 2D covalent organic frameworks (COFs) offers considerable potential in advancing solid-state electrolytes. COFs, with their well-ordered porous and rigid structures, serve as effective solid-state electrolyte fillers, facilitating ionic conduction and boosting battery performance, especially when functional moieties are anchored onto the backbone or side chains. Tailoring the chemical structure of COFs can suppress unwanted side reactions within the electrolyte, enhancing stability and prolonging battery life. [7] Additionally, using COF fillers can improve mechanical strength without compromising flexibility by modulating the molecular structure, which contributes to battery stability under conditions such as vibration and deformation. The COF matrix also promotes stable interfacial structures, reducing impedance and improving battery efficiency and cycling stability. [8]

By strategically designing COF structures and employing synthetic approaches—such as controlling pore size, regulating surface chemistry, and optimizing electron and ion transport capabilities—COF materials can be multifunctionalized to maximize the performance of solid-state electrolytes. [9] However, a significant challenge remains in the rational design of 2D COF frameworks that can efficiently regulate electronic structure and lithium-ion transport properties while achieving low filler loading, high ionic conductivity, and substantial lithium-ion transport numbers in advanced solid polymer electrolytes (SPEs). [10]

Therefore, addressing these challenges is critical and warrants further research and development. The present invention responds to this need, advancing the field of solid-state electrolytes by leveraging the potential of COF materials. [11]

### SUMMARY OF THE INVENTION

It is an objective of the present invention to provide device, material, or method to solve the aforementioned technical problems.

In accordance with a first aspect of the present invention, a lithium metal solid-state battery is provided. Specifically, the lithium metal solid-state battery includes:
a lithium metal anode;
a cathode, including an active material, a conductive material, a binder, and a current collector, and the active material includes one or more lithium-based materials selected from the group consisting of lithium cobalt oxide, lithium nickel manganese cobalt oxide, lithium iron phosphate, lithium manganese oxide, lithium sulfur, and lithium nickel cobalt aluminum oxide;
at least one porous polymer separator having a porosity from approximately 30% to 90%; and
a solid-state electrolyte, including an organogel includes COFs fabricated by the condensation of monomers with a formula selected from:

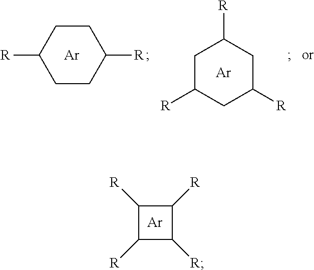

the “R” represents alkyl chain.

In accordance with one embodiment of the present invention, the alkyl groups of the alkyl chain are substituted by amino or aldehyde groups for condensation.

In accordance with another embodiment of the present invention, the alkyl chain includes at least one methylene.

In accordance with one embodiment of the present invention, the substituted monomers include diamino-monomers, triamimo-monomers, tetraamimo-monomers, dialdehyde-monomers, trialdehyde-monomers, and tetraaldehyde-monomers.

In accordance with one embodiment of the present invention, the COFs have a formula of:

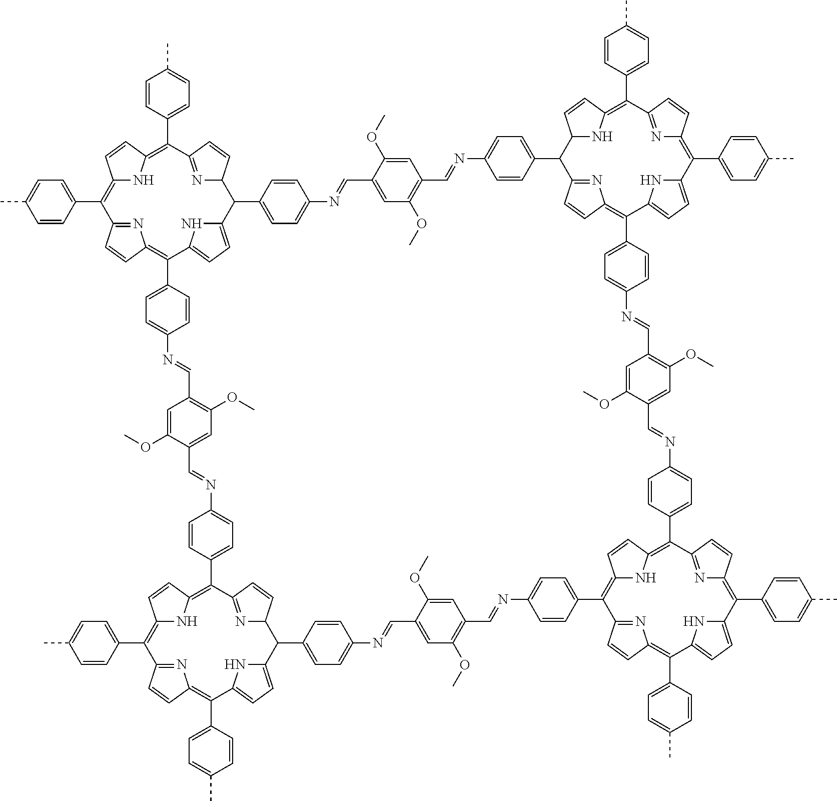

In accordance with one embodiment of the present invention, the at least one porous polymer separator is selected from a polypropylene separator, a polyethylene separator, a cellulose separator, or a glass cellulose separator.

In accordance with one embodiment of the present invention, the conductive material includes one or more conductive carbon materials selected from the group consisting of Super P, Ketjen Black, and carbon nanotubes; the binder comprises polyvinylidene fluoride (PVDF), and the current collector is selected from copper foil or aluminum foil.

In accordance with one embodiment of the present invention, the organogel has a porous and rigid structure that promotes efficient lithium-ion transport.

In accordance with a second aspect of the present invention, a method for assembling the aforementioned lithium metal solid-state battery is introduced. The method includes:
assembling the lithium metal anode, the cathode, and the at least one porous polymer separator;
introducing an organogel precursor solution of the solid-state electrolyte between the lithium metal anode and the cathode; and
gelatinating the organogel precursor solution to form the solid-state electrolyte.

In accordance with one embodiment of the present invention, the gelatinization is conducted by standing at room temperature for 8-24 hours or by heating at 45° C. for 8-24 hours.

In accordance with another embodiment of the present invention, the organogel precursor solution includes COF monomers, polymer monomers, a thermal initiator, a cross-linking agent, and a lithium salt.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the invention are described in more details hereinafter with reference to the drawings, in which:

FIG. 1 depicts a synthetic route of a COF sample in according to one embodiment of the present invention;

FIG. 2 depicts a synthetic route of precursor solution containing COF in according to one embodiment of the present invention;

FIG. 3 shows polarization curves with the initial and steady-state impedance diagram of PDA@CityU43 at room temperature, in which there is an inset depicting the Nyquist plots of the symmetrical batteries;

FIG. 4 shows the polarization curves with the initial and steady-state impedance diagram of PDA at room temperature, in which there is an inset depicting the Nyquist plots of the symmetrical batteries;

FIG. 5 depicts the impedance diagrams of PDA@CityU43 at different temperatures;

FIG. 6 depicts the Arrhenius plots of ionic conductivity of PDA and PDA@CityU43;

FIG. 7 shows the linear sweep voltammetry (LSV) curves of PDA and PDA@CityU43 at room temperature;

FIG. 8 depicts the Tafel plots of Li∥Li cells assembled using the PDA and PDA@CityU43 with a voltage scan from −0.25 to 0.25 V (vs Li+/Li) at 1 mV s⁻¹;

FIG. 9 shows the galvanostatic cycling of symmetric lithium cells with PDA and PDA@CityU43;

FIG. 10 depicts the critical current density (CCD) of PDA and PDA@CityU43;

FIG. 11 depicts the rate performance of Li∥Li cells assembled using the PDA and PDA@CityU43;

FIGS. 12A-12D are SEM images showing the lithium anode surfaces and cross-sections after cycling reveals, in which FIG. 12A shows the surface of PDA after cycling, FIG. 12B displays the surface of PDA@CityU43 after cycling, FIG. 12C shows the cross section of PDA after cycling, and FIG. 12D depicts the cross section of PDA@CityU43 after cycling;

FIG. 13 depicts the cycling performance of LiFePO₄∥Li batteries with PDA and PDA@CityU43 electrolytes; and

FIG. 14 depicts the cycling performance of NCM₈₁₁∥Li batteries with PDA and PDA@CityU43 electrolytes.

### DETAILED DESCRIPTION

In the following description, lithium metal solid-state batteries with covalent organic framework (COF) organogel as electrocyte and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The term “solid-state electrolyte” used herein refers to a material that conducts ions and is used in place of a traditional liquid electrolyte in electrochemical devices, such as batteries and fuel cells. Unlike liquid electrolytes, solid-state electrolytes are in a solid phase and can be made from ceramic, glass, polymer, or composite materials. They enable the movement of ions between the electrodes in a battery while preventing the flow of electrons, which is essential for maintaining the separation of charge and allowing the electrochemical reactions to occur. Solid-state electrolytes offer advantages such as enhanced safety (due to reduced risk of leakage or combustion), improved thermal stability, and the potential for higher energy density compared to liquid electrolytes.

The term “composite solid-state electrolytes (CSEs)” are materials that combine a solid electrolyte matrix, typically a polymer or ceramic, with various fillers or additives to enhance the performance of solid-state batteries. The composite structure integrates the beneficial properties of both the solid electrolyte matrix and the additives, which can include inorganic particles, organic materials, or a mixture of both. CSEs are designed to improve key characteristics such as ionic conductivity, mechanical strength, electrochemical stability, and interfacial compatibility with battery electrodes.

In lithium-ion batteries, CSEs often consist of a solid polymer or ceramic electrolyte infused with inorganic fillers, such as oxides, sulfides, or covalent organic frameworks (COFs). These additives help to enhance lithium-ion transport, reduce interfacial resistance, and improve thermal and mechanical properties, while maintaining the safety benefits of a solid electrolyte. CSEs aim to overcome the limitations of pure solid electrolytes, such as low ionic conductivity or poor flexibility, by combining the best features of multiple materials.

The term “organogel” used herein refers to a semi-solid material formed by the gelation of an organic liquid (often an organic solvent) with a small amount of a gelling agent. The gelling agent typically forms a three-dimensional network that traps the organic liquid, resulting in a gel-like structure. Organogels are thermodynamically stable, can be either thermoreversible or thermostable, and retain the properties of both solids (shape and stability) and liquids (solvent within the network).

The term “covalent organic framework (COF) organogel” is a semi-solid material formed by incorporating COF materials into a gel matrix. COF materials are characterized by their highly ordered porous structures and intermolecular electron transfer capabilities, which facilitate effective ion conduction. This makes them particularly useful in improving the performance of solid-state electrolytes. In the context of lithium batteries, COF organogels enhance ion transport while maintaining mechanical stability.

In accordance with a first aspect of the present invention, a lithium metal solid-state battery that incorporates advanced materials to improve performance, safety, and stability is provided. This battery includes a lithium metal anode, which provides high energy density due to the inherent advantages of lithium metal as an anode material. The cathode consists of multiple components, including an active material, a conductive material, a binder, and a current collector. The active material in the cathode may include one or more lithium-based compounds, specifically selected from the group of lithium cobalt oxide, lithium nickel manganese cobalt oxide, lithium iron phosphate, lithium manganese oxide, lithium sulfur, and lithium nickel cobalt aluminum oxide. These materials are chosen for their ability to enhance the overall electrochemical performance and energy density of the battery.

The battery further includes at least one porous polymer separator, with a porosity ranging from approximately 30% to 90%. This separator provides crucial functions, including separating the anode and cathode while allowing the passage of lithium ions, thereby contributing to the overall ionic conductivity and stability of the battery system. The separator may be constructed from materials such as polypropylene, polyethylene, cellulose, or glass cellulose, depending on the desired application and performance criteria.

A key component of this lithium metal solid-state battery is the solid-state electrolyte, which includes an organogel. The organogel is formed from COFs fabricated by the condensation of monomers, with a formula selected from:

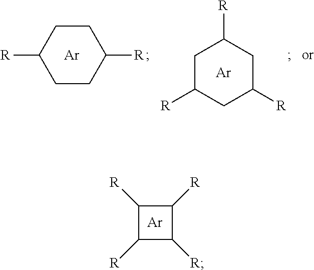

where “R” represents an alkyl chain.

The alkyl chain in these COF monomers is essential for the polymerization and can be modified to include substitutions such as amino or aldehyde groups, which facilitate the condensation process. These substitutions enhance the versatility and reactivity of the COFs during synthesis, making them ideal for use in advanced solid-state electrolyte formulations. The alkyl chain itself may include at least one methylene group, which contributes to the structural stability and flexibility of the COF framework within the organogel.

In some embodiments, the COF monomers used for the solid-state electrolyte may include diamino-monomers, triamino-monomers, tetraamino-monomers, dialdehyde-monomers, trialdehyde-monomers, or tetraaldehyde-monomers. These monomers allow for the formation of highly ordered porous and rigid structures in the COF-based organogel, which significantly enhances the ion transport properties within the solid-state electrolyte. The resulting COFs have the following formula:

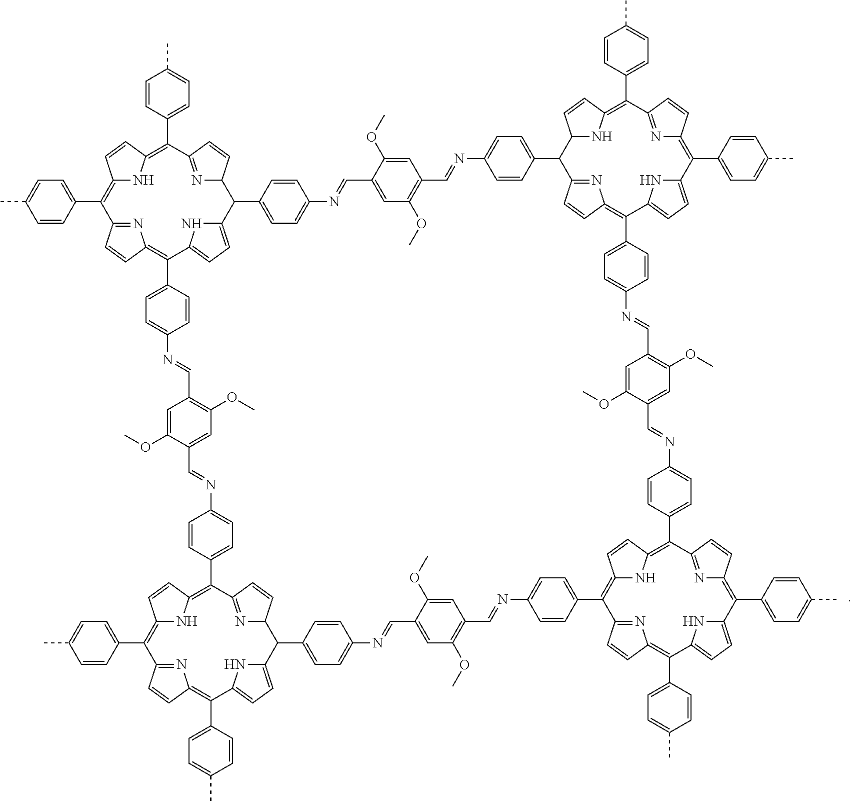

The conductive material in the cathode can include one or more conductive carbon-based materials, such as Super P, Ketjen Black, or carbon nanotubes. These materials are integrated into the cathode to enhance its electronic conductivity, ensuring efficient electron transfer during the battery's charge and discharge cycles. The binder used in the cathode formulation is polyvinylidene fluoride (PVDF), which provides structural cohesion to the cathode components. The current collector, essential for transferring electrons to and from the external circuit, is selected from either copper foil or aluminum foil, depending on the specific design requirements of the battery.

The organogel used in the solid-state electrolyte has a porous and rigid structure, which plays a critical role in facilitating efficient lithium-ion transport between the anode and cathode. The porous nature of the COF-based organogel allows for enhanced ionic conductivity, contributing to the overall performance and longevity of the battery. This ensures that the solid-state electrolyte not only maintains mechanical stability but also enhances the electrochemical behavior of the battery under various operating conditions.

It is worth noting that the HCPE described herein can be further used as an electrolyte for energy storage devices, such as the sodium metal battery or lithium metal battery described herein. The battery can be in the form of, for example, a coin/button battery, a coin bag battery, a bag battery, a cylindrical battery, a prismatic battery, etc. In one embodiment, the energy storage device can be in the form of a coin battery, such as a half coin battery or a full coin battery.

In accordance with a second aspect of the present invention, the present invention further provides a method for assembling the aforementioned lithium metal solid-state battery. This method ensures the proper integration of the lithium metal anode, the cathode, the porous polymer separator, and the solid-state electrolyte into a cohesive and high-performance battery unit.

In this assembly method, the lithium metal anode is first positioned in conjunction with the cathode and at least one porous polymer separator, which may be selected from materials such as polypropylene, polyethylene, cellulose, or glass cellulose. The polymer separator serves as a crucial barrier between the anode and cathode while allowing for the passage of lithium ions, ensuring efficient ion transport and preventing short circuits.

After the physical components are assembled, an organogel precursor solution is introduced between the lithium metal anode and the cathode. This precursor solution, which will form the solid-state electrolyte, is carefully applied to ensure that it fully occupies the space between the electrodes, thereby creating a continuous medium for ion transport. The precursor solution typically contains a combination of COF monomers, polymer monomers, a thermal initiator, a cross-linking agent, and a lithium salt. The COF monomers provide the necessary porous and rigid structure for effective ion conduction, while the polymer monomers contribute to the mechanical integrity of the organogel. The lithium salt is included to ensure sufficient ionic conductivity within the electrolyte.

In one embodiment, the precursor solution includes 1,3-dioxopentacene (DOL), acrylamide (AAm) as the polymer monomers, azobisisobutyronitrile (AIBN) as the thermal initiator, COF as an additive, poly(ethylene glycol) diacrylate (PEGDA) as the cross-linking agent, and lithium bis(trifluoromethane) sulfonylimide (LiTFSI) as the lithium salt.

In one embodiment, AAm is first dissolved in a DOL solution at a concentration of 10-40 wt %, preferably 20 wt %. AIBN, COF, PEGDA are sequentially added to the above DOL solution of Aam at a mass of 0.1 wt % to 0.5 wt % of Aam, respectively. The precursor solution is ultrasonically mixed homogeneously to ensure that the COF is well dispersed and the monomer diffuses into the one-dimensional oriented nano-channels of the COF.

Following the introduction of the organogel precursor solution, a process of gelatinization is carried out to transform the liquid precursor into a solid-state electrolyte. This gelatinization can be conducted in one of two ways: the solution can either be left to stand at room temperature for a period of 8 to 24 hours, allowing the gelation process to occur naturally, or it can be heated to a controlled temperature of approximately 45° C. for 8 to 24 hours. The controlled heating process may accelerate gelatinization and improve the uniformity of the solid-state electrolyte. The gelatinization step ensures that the solid-state electrolyte is fully formed and that it provides the necessary ionic pathways for lithium-ion movement while maintaining mechanical stability.

The resulting organogel solid-state electrolyte, once gelatinized, exhibits a well-structured porous network that facilitates efficient lithium-ion transport, ensuring optimal electrochemical performance of the battery. The incorporation of COF monomers within the organogel precursor solution enhances the electrolyte's ionic conductivity and mechanical strength, addressing common challenges faced in solid-state battery design, such as ion transport limitations and material degradation over time.

In another embodiment, the components of the battery are assembled as the above order, and the battery is packed together with a pressure of about 0.1 kPa to about 1.5 kPa, about 0.5 kPa to about 1.0 kPa, or about 0.75 kPa to about 0.85 kPa. The assembly step may include the following steps in order: placing the anode, dripping the precursor solution (about 10 to 100 μL), placing the diaphragm, dripping the precursor solution again (about 10 μL to 100 μL), and placing the cathode.

### EXAMPLES

Unless otherwise specifically provided, all tests herein are conducted at standard conditions which include a room and testing temperature of 25° C., sea level (1 atm.) pressure, pH 7, and all measurements are made in metric units. Furthermore, all percentages, ratios, etc. herein are by weight, unless specifically indicated otherwise. It is understood that unless otherwise specifically noted, the materials compounds, chemicals, etc. described herein are typically commodity items and/or industry-standard items available from a variety of suppliers worldwide. All the reagents and solvents are used without further purification unless otherwise specified. The n-butanol, 1,2-dichlorobenzene, and 1,4-dioxane are purchased as extra dry grade with water lower than 50 ppm.

### Example 1. Fabrication of the COF

### COF Monomer Preparation

Hydroxyl-substituted aromatic precursor and halogenated alkyl agent are mixed at a mole ratio of 1:2 or 1:3 or 1:4 or 1:5 using polar solvent such as N,N-dimethylformamide (DMF) or N,N-Dimethylacetamide (DMAc) or N-methylpyrrolidone (NMP) or acetonitrile under argon or nitrogen atmosphere. Stirring the mixture at 80-120° C. for 8-24 hr, the alkyl chain may be anchored and may be represented by the following structures.

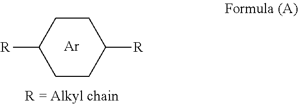

Hydroxyl-substituted aromatic precursor and halogenated alkyl agent are mixed at a mole ratio of 1:2 or 1:3 or 1:4 or 1:5 or 1:6 using polar solvent such as N,N-dimethylformamide (DMF) or N,N-Dimethylacetamide (DMAc) or N-methylpyrrolidone (NMP) or acetonitrile under argon or nitrogen atmosphere. Stirring the mixture at 80-120° C. for 8-24 hr, the alkyl chain may be anchored and may be represented by the following structures.

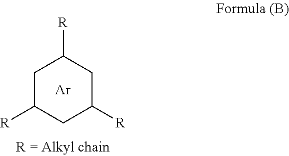

Hydroxyl-substituted aromatic precursor and halogenated alkyl agent are mixed at a mole ratio of 1:2 or 1:3 or 1:4 or 1:5 or 1:6 or 1:7 using polar solvent such as N,N-dimethylformamide (DMF) or N,N-Dimethylacetamide (DMAc) or N-methylpyrrolidone (NMP) or acetonitrile under argon or nitrogen atmosphere. Stirring the mixture at 80-120° C. for 8-24 hr, the alkyl chain may be anchored and may be represented by the following structures.

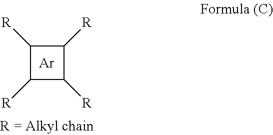

### COF Preparation

1,2-Dichlorobenzene or n-butanol or mesitylene or 1,4-dioxane or the mixture of them are used as the solvent to disperse alkyl substituted amino and aldehyde monomer with a mole ratio of 1:1.5, where acetic acid (HOAc, 6M) is used as catalyst for the condensation reaction. After three or more cycles of freeze-pump-thaw, the mixture is heated at 80-150° C. for about 3-7 days. The obtained powder is filtered and washed with diverse solvents including N,N-dimethylformamide (DMF), tetrahydrofuran (THF), dichloromethane (DCM), acetone and n-hexane before further purification through Soxhlet extraction using THF. The obtained COF structure may be represented by the following structures.

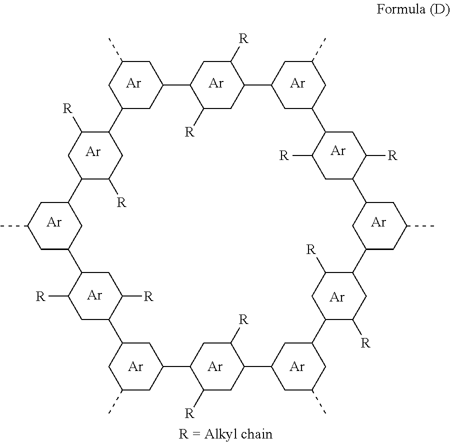

1,2-dichlorobenzene or n-butanol or mesitylene or 1,4-dioxane or the mixture of them are used as the solvent to disperse alkyl substituted amino and aldehyde monomer with a mole ratio of 1:2, where acetic acid (HOAc, 6M) is used as catalyst for the condensation reaction. After three or more cycles of freeze-pump-thaw, the mixture is heated at 80-150° C. for about 3-7 days. The obtained powder is filtered and washed with diverse solvents including N,N-dimethylformamide (DMF), tetrahydrofuran (THF), dichloromethane (DCM), acetone and n-hexane before further purification through Soxhlet extraction using THF. The obtained COF structure may be represented by the following structures.

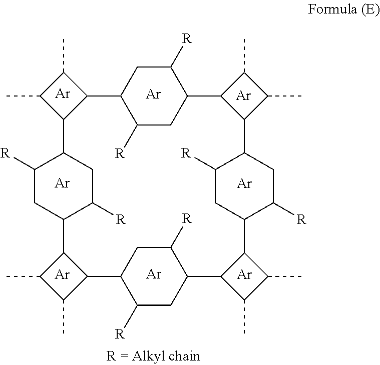

As stated in the above preparation processes, the process for preparing piezoelectric COFs with fluorinated alkyl chains as described herein is undertaken in mild and simple conditions. Hence, this method may be scaled-up in a straightforward manner.

### Synthesis of a COF Sample, TAPP-DMTA COF

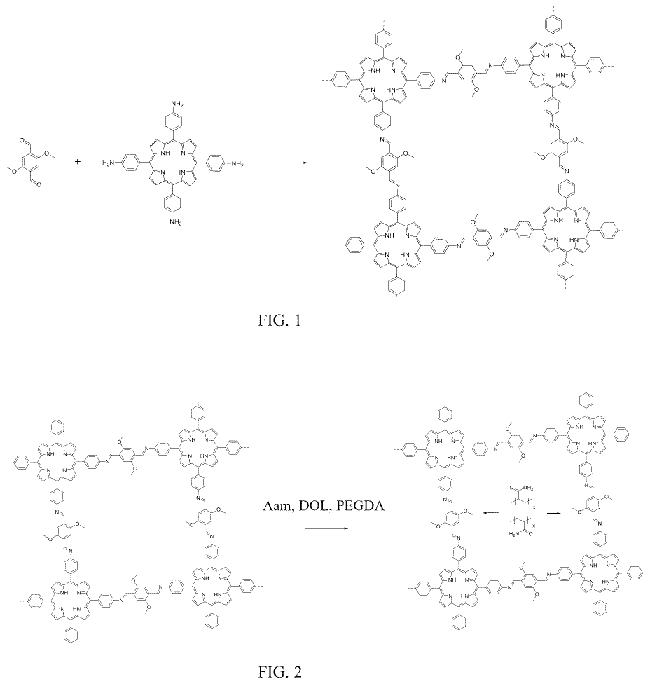

The synthetic route is as depicted in FIG. 1. Loading 27 mg of 5,10,15,20-tetrakis(4-aminophenyl)-21H,23H-porphine (TAPP, 0.04 mmol) and 15.6 mg of 2,5-dimethoxyterephthalaldehyde (DMTA, 0.08 mmol) into a pyrex tube. Before injecting 0.4 mL of acetic acid (HOAc, 6M) as catalyst for the condensation reaction, 1.0 mL of mesitylene and 1.0 mL of 1,4-dioxane are added into the pyrex to disperse the reactants by sonication. After three cycles of freeze-pump-thaw, the mixture is put into the oven and heated at 80-150° C. for 3-7 days. The obtained powder is filtered and washed with diverse solvents including N,N-dimethylformamide (DMF), tetrahydrofuran (THF), dichloromethane (DCM), acetone and n-hexane before further purification through Soxhlet extraction using THF.

Preparation of Precursor Solution with COF

TAPP-DMTA COF (0.1 wt % of monomer) is added to the DOL solution of AAM (33 wt %), followed by the addition of PEGDA chemical crosslinker (0.1 wt % of monomer) and AIBN (0.5 wt % of monomer). The mixture is stirred well and sonicated for 5 h to ensure that the COF is well dispersed and the monomer diffused into the 1D aligned nanochannels of the COF for the formation of PDOL-co-PAAM@CityU-43 (PDA@CityU-43). The synthetic route is depicted in FIG. 2.

### Example 2. Manufacture of the Lithium Metal Solid-State Battery with COF Containing Solid-State Electrolyte

The energy storage device is in the form of a coin cell. The components in the coin cell include: anode, separator, electrolyte, cathode assembled in the following order. The anode can be a metal sheet, such as a metal foil, a metal disk, etc. The separator can be a polypropylene separator, a polyethylene separator, a cellulose separator, or a glass cellulose separator. The electrolyte uses a prepared precursor solution.

The cathode can include an active material, a conductive material, a binder, and a current collector. The conductive material can include conductive carbon, such as Super P, Ketjen Black, or carbon nanotubes. The binder can include PVDF. The current collector can be copper foil or aluminum foil. The active material can use lithium iron phosphate, ternary materials, sulfur positive electrode, etc. It is best to center the cathode with the anode as much as possible to avoid uneven current density.

The precursor solution comprises, DOL, AAm, AIBN as a thermal initiator, COF as an additive, PEGDA as a cross-linking agent, and LiTFSI as a lithium salt. AAm is first dissolved in a DOL solution at a concentration of 10-40 wt %, preferably 20 wt %. AIBN, COF, PEGDA are sequentially added to the above DOL solution of Aam at a mass of 0.1 wt % to 0.5 wt % of Aam, respectively. The above precursor solution is ultrasonically mixed homogeneously to ensure that the COF is well dispersed and the monomer diffuses into the one-dimensional oriented nano-channels of the COF.

The preparation of the battery with the precursor solution includes the step of:

The components of the device are assembled in the above order, and the battery is packed together with a pressure of about 0.1 kPa to about 1.5 kPa, about 0.5 kPa to about 1.0 kPa, or about 0.75 kPa to about 0.85 kPa. The assembly step may include the following steps in order: placing the anode, dripping the precursor solution (about 10 to 100 μL), placing the diaphragm, dripping the precursor solution again (about 10 μL to 100 μL), and placing the cathode.

The assembled battery needs to stand at room temperature for 8-24 hours, and then transfer to a 45° C. oven for heating for 8-24 hours until the electrolyte is completely solidified. The successful polymerization of HCPE is visually demonstrated by the transition of the initial liquid precursor to a non-fluid flexible solid electrolyte.

For emphasizing the better properties of the lithium metal solid-state battery of the present invention, a battery without COF is assembled as a control.

Particularly, the precursor solution without COF, named as PDA, includes, DOL, AAm, AIBN as a thermal initiator, PEGDA as a cross-linking agent, and LiTFSI as a lithium salt. The DOL solution of AAM (33 wt %), followed by the addition of PEGDA chemical crosslinker (0.1 wt % of monomer) and thermal initiator AIBN (0.5 wt % of monomer). The mixture was stirred well and sonicated for 5 h.

Next, a lithium disk is first placed to the case. Then dripping the precursor solution without COF (60 μL), placing the separator, dripping the precursor solution without COF again (60 μL), and placing another lithium disk. Finally, the other case is placed on top and the coin cell was packed with 0.8 kPa pressure. The assembled battery needs to stand at room temperature for 8 hours, and then transfer to a 45° C. oven for heating for 12 hours until the electrolyte is completely solidified.

### Example 3. Fabrication of a Symmetrical LMB Coin Cell with the PDA@CityU-43 Precursor

A lithium disk is first placed to the case. Then dripping the precursor solution PDA@CityU-43 (60 μL), placing the separator, dripping the precursor solution PDA@CityU-43 (60 μL), and placing another lithium disk. Finally, the other case is placed on top and the coin cell is packed with 0.8 kPa pressure. The assembled battery needs to stand at room temperature for 8 hours, and then transfer to a 45° C. oven for heating for 12 hours until the electrolyte is completely solidified.

### Example 4. Electrochemical Performance of Symmetrical LMB Coin Cell with the PDA@CityU43 Electrolyte

Coin cells of CR2032, assembled in an argon-filled glovebox (O₂≤0.1 ppm, H₂O≤0.1 ppm), are used to investigate the electrochemical performance of the PDA@CityU43 electrolyte.

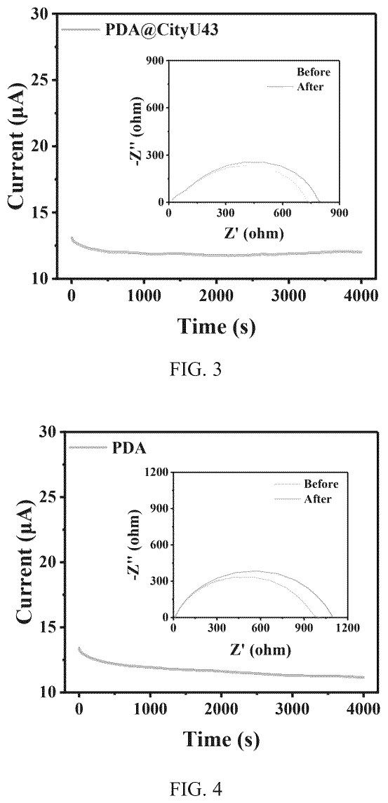

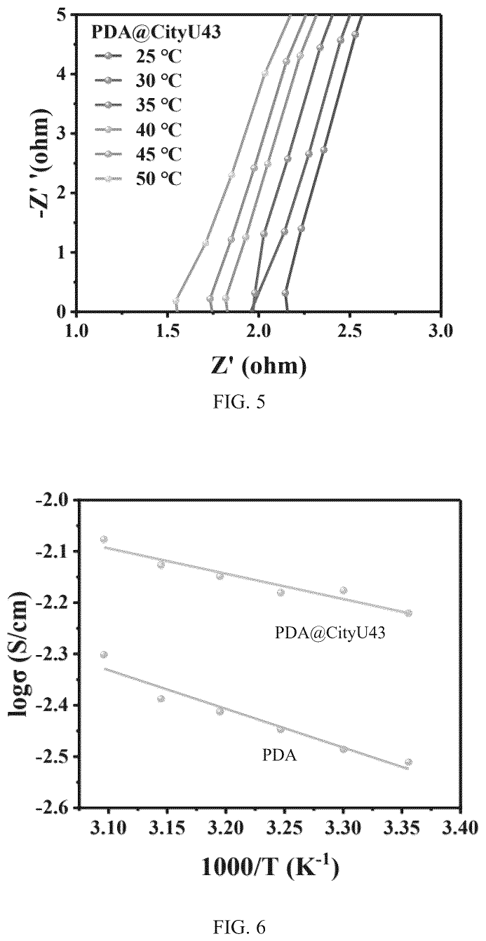

As shown in FIG. 3 and FIG. 4, the lithium-ion transport number of PDA@CityU43 is determined to be 0.82, which is significantly higher than that of the linear PDA electrolyte (approximately 0.68). This improvement is attributed to the increased Li+ concentration and the restricted motion of the conducting ions, effectively reducing polarization during the charging and discharging processes. To further assess the ionic conductivity of the hybrid crosslinked polymer electrolyte (HCPE), electrochemical impedance spectroscopy (EIS) is performed on the assembled cells at various temperatures (FIG. 5). The results reveal a linear increase in ionic conductivity with temperature, with a significant enhancement observed upon the addition of CityU-43. Specifically, at room temperature, the ionic conductivity increases from 3.09E-03 S/cm to 6.02E-03 S/cm with the incorporation of the COF. The corresponding ionic conductivity and temperature dependence curves are illustrated in FIG. 6.

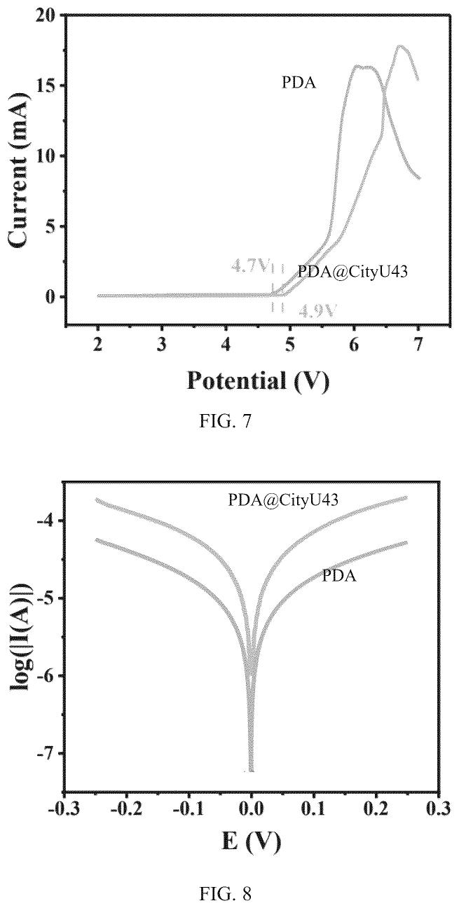

The temperature-dependent behavior of the HCPE's ionic conductivity aligns well with the Arrhenius equation, indicating an activation energy of 0.75 eV for PDA, compared to 0.49 eV for PDA@CityU43. This suggests that the energy barrier for lithium-ion transport in PDA@CityU43 is lower, enabling faster ion transport kinetics. Expanding the electrolyte's electrochemical window is crucial for compatibility with high-voltage cathode materials. To evaluate this, linear sweep voltammetry (LSV) is employed to measure the electrochemical stability window of PDA@CityU43, demonstrating improved oxidative stability up to 4.9 V (FIG. 7).

To analyze the kinetics of Li+ transfer, current-voltage polarization scans were performed at constant potentials ranging from −0.25 to 0.25 V in symmetric Li∥Li cells. The kinetics of Li+ transfer are depicted in FIG. 8, showing that the exchange current density of PDA@CityU43 increases from 7.8×10⁻⁶ A/cm² to 3×10⁻⁵ A/cm². This high Li+ transfer rate is likely due to the formation of a stable SEI at the interface between the HCPE and the lithium anode. Additionally, impedance spectra indicate that PDA@CityU43 exhibits low intrinsic and interfacial resistance, suggesting improved interfacial contact and compatibility with lithium metal.

These findings demonstrate the high ionic conductivity and enhanced lithium mobility provided by the PDA@CityU43 hybrid crosslinked solid electrolyte. The low resistance, expanded electrochemical window, and improved interfacial properties highlight the potential of this solid electrolyte for high-performance solid-state batteries, particularly in enhancing interfacial contact and compatibility with lithium metal anodes.

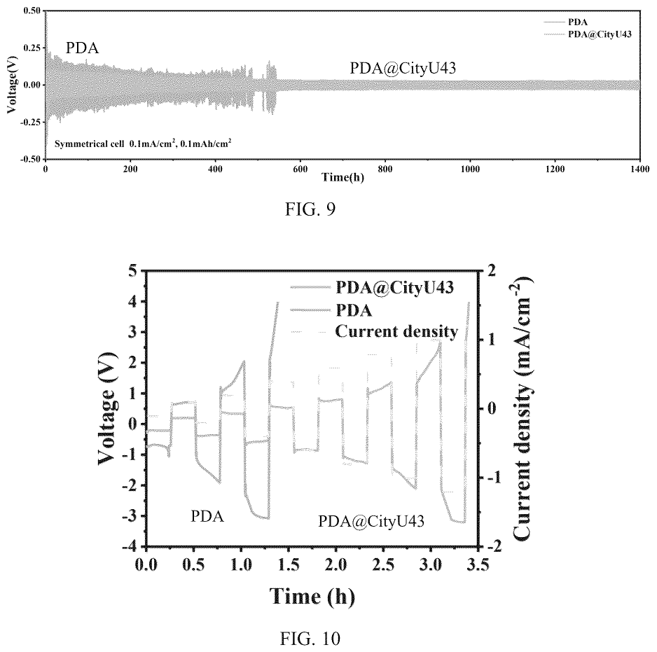

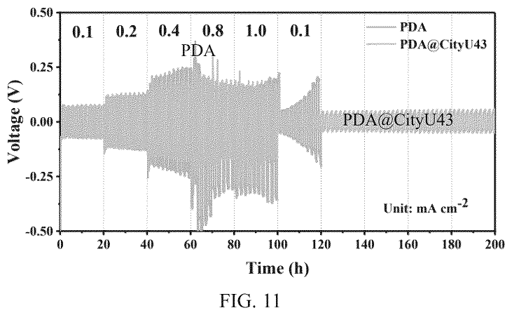

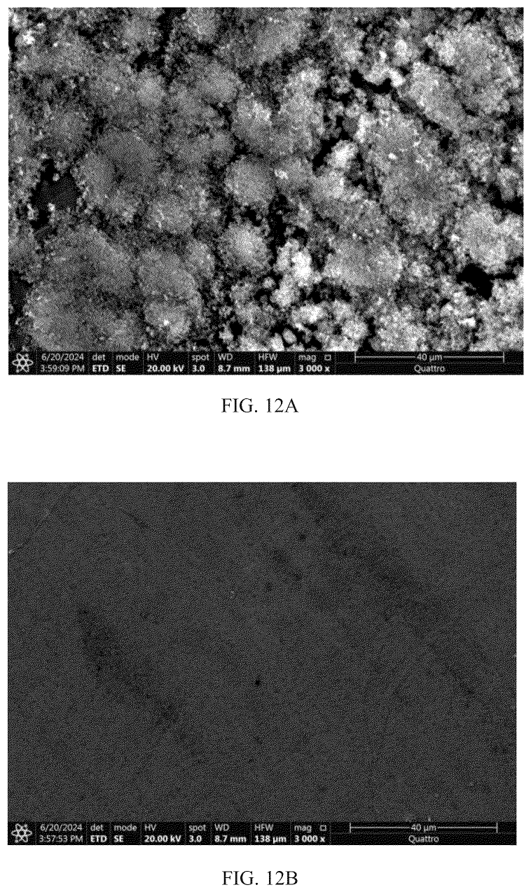

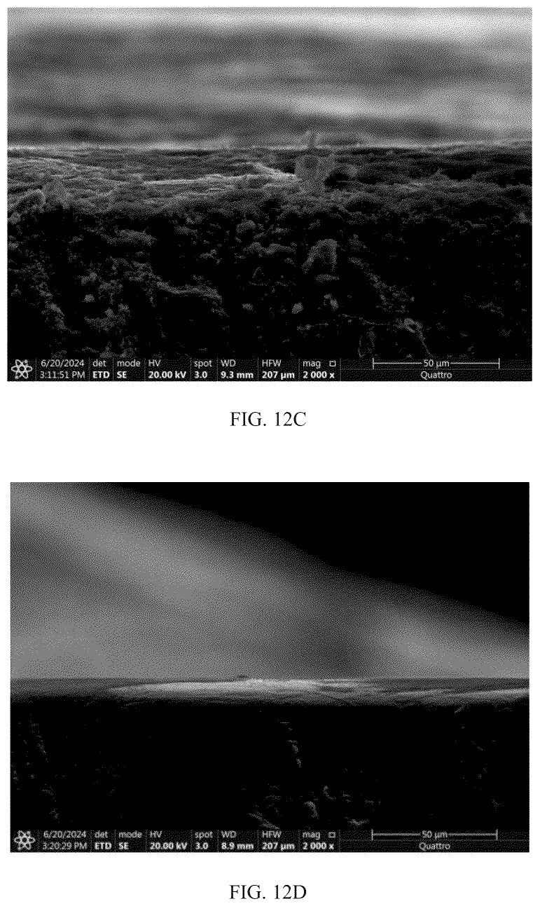

Symmetric Li∥Li batteries are constructed using PDA and PDA@CityU43 electrolytes, and plating/stripping is carried out at a constant current density of 0.1 mA cm⁻² for 1 hour. Cycling performance of the PDA and PDA@CityU43 electrolytes is comparatively analyzed (FIG. 9), revealing that PDA@CityU43 demonstrates a stable initial overpotential (˜107 mV) that is decreased to 33 mV post-stabilization, while PDA exhibits an initial overpotential of up to 250 mV and significant fluctuation after 400 hours before failure. This behavior is attributed to rapid lithium dendrite growth and “dead lithium” deposition from uneven lithium-ion transport. In contrast, the PDA@CityU43-based cell exhibits stable cycling for over 1400 hours with minimal change in overpotential, showcasing superior stability in inhibiting lithium dendrite formation and facilitating uniform lithium deposition. Further verification of cycling performance at high currents shows that PDA@CityU43 can endure a current of 1.2 mA/cm⁻² due to enhanced Li-ion transport, significantly improving battery safety compared to the PDA variant, which can only withstand 0.4 mA/cm⁻² (FIG. 10). Multiplicative performance confirms the superior high-current tolerance of PDA@CityU43, as it cycles efficiently at various current densities (0.1, 0.2, 0.4, 0.8, 1.0 mA/cm⁻²) with stable overpotentials. A lack of unstable fluctuations when dropping back to 0.1 mA/cm⁻² indicates good interfacial compatibility between HCPE and lithium metal electrodes (FIG. 11). Morphological evaluation of lithium anode surfaces and cross-sections after cycling reveals through SEM images (FIGS. 12A-12D) that PDA@CityU43 displays minimal dendrite growth or defects after 100 hours, presenting a stark contrast to the uneven lithium dendrites and dead lithium accumulation observed on the PDA surface. The effective transport and uniform distribution of lithium ions with PDA@CityU43 significantly inhibit lithium dendrite growth, ensuring high electrochemical stability while mitigating electrolyte corrosion and excessive lithium electrode consumption. These findings underscore the potential suitability of HCPE for long-life, high-security battery applications.

### Example 5. Fabrication of the LFP Cathode

LFP powder, Ketjen Black, and polyvinylidene fluoride (PVDF) are mixed in N-methyl-2-pyrrolidone (NMP) with a mass ratio of 8:1:1. The obtained slurry is pasted onto an Al foil and dried at 80° C. for 12 h in a vacuum oven, and thereby the LFP cathode is obtained.

### Example 6. Fabrication of the NCM811 Cathode

NCM811 powder, Ketjen Black, and polyvinylidene fluoride (PVDF) are mixed in N-methyl-2-pyrrolidone (NMP) with a mass ratio of 8:1:1. The obtained slurry is pasted onto an Al foil and dried at 80° C. for 12 h in a vacuum oven, and thereby the NCM811 cathode is obtained.

### Example 7. Fabrication of a Li∥LFP Coin Cell with the PDA Precursor

A lithium disk is first placed into the battery case. Next, 60 μL of the precursor solution without COF, PDA, is carefully applied, followed by placing the separator on top. An additional 60 μL of the PDA precursor solution is then added. After this, the LFP cathode, as described in Example 5, is positioned on top of the separator. Finally, the other half of the battery case is placed over the assembly, and the coin cell is sealed under 0.8 kPa of pressure. The assembled battery is left to stand at room temperature for 8 hours to allow the initial solidification process to begin. After this, it is transferred to a 45° C. oven and heated for 12 hours to ensure the electrolyte is fully solidified.

### Example 8. Fabrication of a Li∥LFP Coin Cell with the PDA@CityU43 Precursor

A lithium disk is first placed into the battery case. Next, 60 μL of the precursor solution PDA@CityU-43 is carefully applied, followed by placing the separator on top. An additional 60 μL of the PDA@CityU-43 precursor solution is then added. After this, the LFP cathode, as described in Example 5, is positioned on top of the separator. Finally, the other half of the battery case is placed over the assembly, and the coin cell is sealed under 0.8 kPa of pressure. The assembled battery is left to stand at room temperature for 8 hours to allow the initial solidification process to begin. After this, it is transferred to a 45° C. oven and heated for 12 hours to ensure the electrolyte is fully solidified.

### Example 9. Fabrication of a Li∥NCM811 Coin Cell with the PDA Precursor

A lithium disk is first placed into the battery case. Next, 60 μL of the PDA precursor solution is carefully applied, followed by placing the separator on top. Another 60 μL of the PDA precursor solution is then added, and the NCM811 cathode, as described in Example 6, is positioned over the separator. Finally, the other half of the battery case is placed on top, and the coin cell is sealed under 0.8 kPa of pressure. The assembled battery is left to stand at room temperature for 8 hours, after which it is transferred to a 45° C. oven and heated for 12 hours to ensure complete solidification of the electrolyte.

### Example 10. Fabrication of a Li∥NCM811 Coin Cell with the PDA@CityU43 Precursor

A lithium disk is first placed into the battery case. Next, 60 μL of the PDA@CityU-43 precursor solution is carefully applied, followed by placing the separator on top. Another 60 μL of the PDA@CityU-43 precursor solution is then added, and the NCM811 cathode, as described in Example 6, is positioned over the separator. Finally, the other half of the battery case is placed on top, and the coin cell is sealed under 0.8 kPa of pressure. The assembled battery is left to stand at room temperature for 8 hours, after which it is transferred to a 45° C. oven and heated for 12 hours to ensure complete solidification of the electrolyte.

### Example 11. Electrochemical Performance of Li∥LFP Coin Cell with the PDA@CityU43 Electrolyte

Coin cells of CR2032 are assembled in an argon-filled glovebox (O₂≤0.1 ppm, H₂O≤0.1 ppm) to investigate the electrochemical performance of the PDA@CityU43 electrolyte.

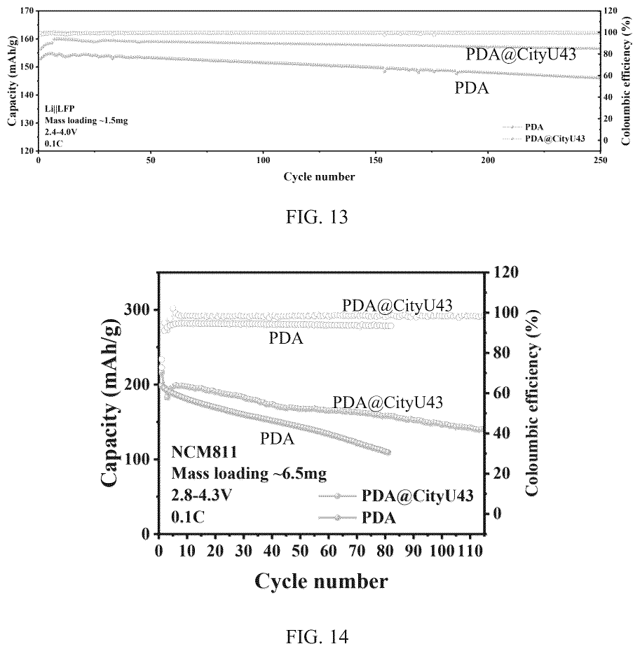

As shown in FIG. 13, the electrochemical performance of the Li∥LFP coin cell with the PDA@CityU43 electrolyte is tested over a voltage range of 2.4-4.0 V. The cell demonstrates high cycling stability, delivering reversible capacities of approximately 155 mAh g⁻¹ at a current density of 0.1 C. Notably, no significant capacity drop is observed after 250 charge/discharge cycles, illustrating the excellent stability of the electrode materials and the robustness of the PDA@CityU43 electrolyte.

### Example 12. Electrochemical Performance of Li∥NCM₈₁₁ Coin Cell with the PDA@CityU43 Electrolyte

Coin cells of CR2032 are assembled in an argon-filled glovebox (O₂≤0.1 ppm, H₂O≤0.1 ppm) to investigate the electrochemical performance of the PDA@CityU43 electrolyte.

As shown in FIG. 14, the electrochemical performance of the Li∥NCM811 coin cell with the PDA@CityU43 electrolyte is tested over a voltage range of 2.8-4.3 V. The cell demonstrates high cycling stability, delivering reversible capacities of approximately 200 mAh g⁻¹ at a current density of 0.1 C. Notably, the capacities is maintained approximately 150 mAh g⁻¹ after 110 charge/discharge cycles, illustrating the excellent properties in high voltage of the electrode materials and the robustness of the PDA@CityU43 electrolyte.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### REFERENCES

[1]: Yayuan Liu et al., An Artificial Solid Electrolyte Interphase with High Li-Ion Conductivity, Mechanical Strength, and Flexibility for Stable Lithium Metal Anodes. Adv. Mater., 2017; 29, 1605531.
[2]: Ekaterina Pomerantseva et al., Energy storage: The future enabled by nanomaterials. Science, 2019; 366, 969.
[3]: Guanghai Chen et al., Hyperbranched polyether boosting ionic conductivity of polymer electrolytes for all-solid-state sodium ion batteries. Chemical Engineering Journal. 2020; 394, 124885.
[4]: Nanwen Li et al., Highly Stable, Anion Conductive, Comb-Shaped Copolymers for Alkaline Fuel Cells. J. Am. Chem. Soc., 2013; 135, 10124-10133.
[5]: Anh Le Mong et al., Tough and Flexible, Super Ion-Conductive Electrolyte Membranes for Lithium-Based Secondary Battery Applications. Adv. Funct. Mater., 2021; 31, 2008586.
[6]: Laura F. Hart et al., Material properties and applications of mechanically interlocked polymers. Nature Reviews Materials., 2021; volume 6.
[7]: Xigui Liu et al., Recent advances in covalent organic frameworks (COFs) as a smart sensing material. Chem. Soc. Rev., 2019; 48, 5266-5302.
[8]: Edon Vitaku et al., Phenazine-Based Covalent Organic Framework Cathode Materials. J. Am. Chem. Soc., 2020; 142, 16-20.
[9]: Kaushik Dey et al., Self-Assembly-Driven Nanomechanics in Porous Covalent Organic Framework Thin Films. J. Am. Chem. Soc., 2021; 143, 955-963.
[10]: Shushan Yuan et al., Covalent organic frameworks for membrane separation. Chem. Soc. Rev., 2019; 48, 2665-2681.
[11]: Keyu Geng et al., Covalent Organic Frameworks: Design, Synthesis, and Functions. Chem. Rev., 2020; 120, 8814-8933.

1. A lithium metal solid-state battery, comprising:
a lithium metal anode;
a cathode, comprising an active material, a conductive material, a binder, and a current collector, wherein the active material includes one or more lithium-based materials selected from the group consisting of lithium cobalt oxide, lithium nickel manganese cobalt oxide, lithium iron phosphate, lithium manganese oxide, lithium sulfur, and lithium nickel cobalt aluminum oxide;
at least one porous polymer separator having a porosity from approximately 30% to 90%; and
a solid-state electrolyte, comprising:
an organogel, wherein the organogel comprises covalent organic frameworks (COFs) fabricated by the condensation of monomers with a formula selected from: 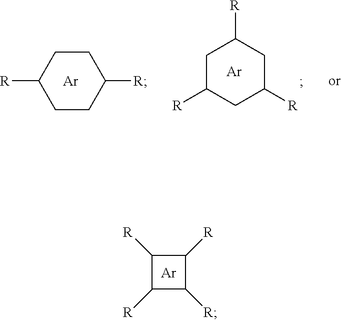
wherein the R is an alkyl chain.

2. The lithium metal solid-state battery of claim 1, wherein the alkyl groups of the alkyl chain are substituted by amino or aldehyde groups for condensation.

3. The lithium metal solid-state battery of claim 1, wherein the alkyl chain comprises at least one methylene.

4. The lithium metal solid-state battery of claim 2, wherein the substituted monomers comprise diamino-monomers, triamimo-monomers, tetraamimo-monomers, dialdehyde-monomers, trialdehyde-monomers, and tetraaldehyde-monomers.

5. The lithium metal solid-state battery of claim 4, wherein the COFs have a formula of:

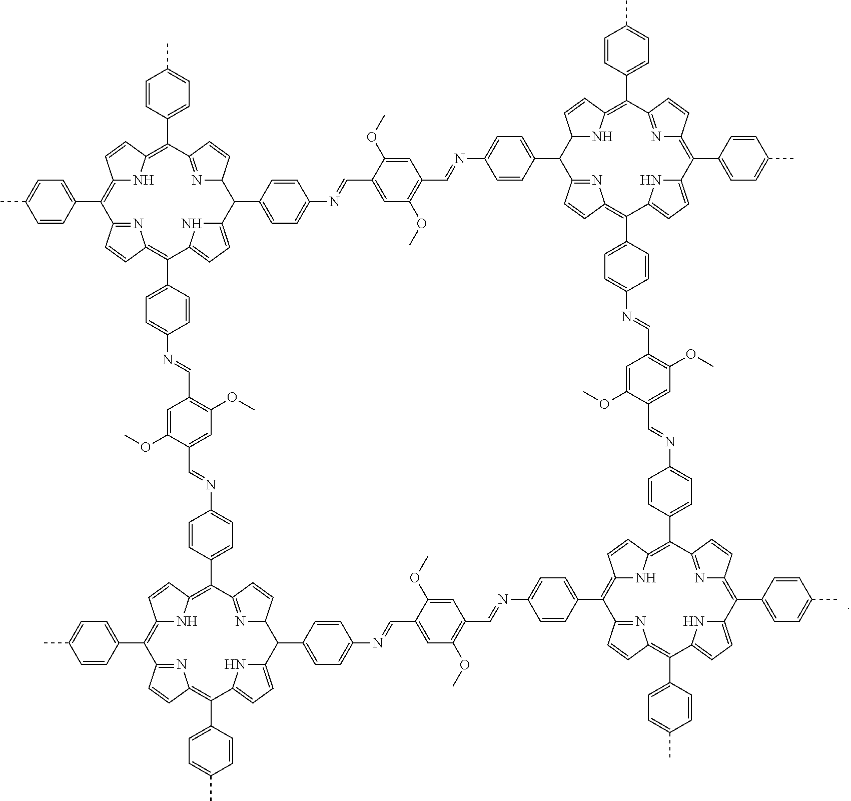

6. The lithium metal solid-state battery of claim 1, wherein the at least one porous polymer separator is selected from a polypropylene separator, a polyethylene separator, a cellulose separator, or a glass cellulose separator.

7. The lithium metal solid-state battery of claim 1, wherein the conductive material includes one or more conductive carbon materials selected from the group consisting of Super P, Ketjen Black, and carbon nanotubes; the binder comprises polyvinylidene fluoride (PVDF), and the current collector is selected from copper foil or aluminum foil.

8. The lithium metal solid-state battery of claim 1, wherein the organogel has a porous and rigid structure that promotes efficient lithium-ion transport.

9. A method of assembling the lithium metal solid-state battery of claim 1, comprising:
assembling the lithium metal anode, the cathode, and the at least one porous polymer separator;
introducing an organogel precursor solution of the solid-state electrolyte between the lithium metal anode and the cathode; and
gelatinating the organogel precursor solution to form the solid-state electrolyte.

10. The method of claim 9, wherein the gelatinization is conducted by standing at room temperature for 8-24 hours or by heating at 45° C. for 8-24 hours.

11. The method of claim 9, wherein the organogel precursor solution comprises COF monomers, polymer monomers, a thermal initiator, a cross-linking agent, and a lithium salt.
